(19) United States
(12) Patent Application Publication
(10) Pub. No.: US 2017/0336686 A1
(43) Pub. Date: Nov. 23, 2017

(54) LIQUID CRYSTAL DISPLAY PANEL

(71) Applicants: Shenzhen China Star Optoelectronics Technology Co. Ltd., Shenzhen (CN); Wuhan China Star Optoelectronics Technology Co. Ltd., Wuhan (CN)

(72) Inventor: Hongqing CUI, Shenzhen (CN)

(73) Assignees: Shenzhen China Star Optoelectronics Technology Co. Ltd., Shenzhen (CN); Wuhan China Star Optoelectronics Technology Co. Ltd., Wuhan (CN)

(21) Appl. No.: 14/897,735

(22) PCT Filed: Oct. 29, 2015
(86) PCT No.: PCT/CN2015/093198

§ 371 Date: Dec. 11, 2015

(30) Foreign Application Priority Data
Oct. 23, 2015 (CN) 201510694979.1

(51) Int. Cl. G02F 1/1362; G06F 3/041; G02F 1/1333; G02F 1/1335

(52) U.S. Cl. CPC G02F 1/136204; G02F 1/133514; G02F 1/133528; G02F 1/1362; G06F 3/0412; G02F 1/13338; G02F 2001/133538; G02F 2201/505; G06F 2203/04107; G06F 2203/04111; G02F 2001/133548

(57) ABSTRACT

Provided is a liquid crystal display panel, comprising an array substrate, a color filter substrate, and a liquid crystal layer disposed therebetween, wherein a photoelectric functional layer, which is arranged on a surface of the color filter substrate facing the liquid crystal layer or on a surface of the color filter substrate away from the liquid crystal layer, can influence polarization states of optical waves, and meanwhile generate electrical shielding effects. As such, the photoelectric functional layer, which has two functions, can serve as either a polarizer or an electrical shielding layer, thus simplifying a manufacturing procedure of the entire liquid crystal display panel.

### CROSS-REFERENCE TO RELATED APPLICATIONS

The present application claims priority of Chinese patent application CN 201510694979.1, entitled “Liquid crystal display panel” and filed on Oct. 23, 2015, the entirety of which is incorporated herein by reference.

### FIELD OF THE INVENTION

The present disclosure relates to the field of display technologies, and in particular to a liquid crystal display panel.

### BACKGROUND OF THE INVENTION

In connection with electrical shielding technologies of liquid crystal display devices, the following three conditions substantially prevail in the prior art.

To start with, for a fringe field switching-liquid crystal display (FFS-LCD) now extensively used, its pixel electrode and common electrode are both placed on a lower glass substrate (array substrate) of a liquid crystal cell, while an upper glass substrate (color filter substrate) is free from any electrode layers thereon. Therefore, accumulation of electrostatic charges on an outer surface of the liquid crystal cell would easily lead to generation of an additional electric field, which can influence alignment of liquid crystal molecules, and thereby cause abnormal display of a picture, i.e., picture abnormality. Directed against this, an additional electrical shielding layer is typically provided on a surface of the upper glass substrate (color filter substrate) for electrical shielding treatment. The material for such an electrical shielding layer can be conductive oxides, such as indium tin oxide (ITO), antimony oxide, tin oxide, zinc oxide, other metal oxides, and alloy oxides. The electrical shielding layer can also be made of a nanometer conductive material, such as carbon nano-tubes, or be made of a conductive polymer film, conductive ink, conductive particles, conductive rods, etc. A layer positioned by these materials can be located on an upper surface or a lower surface of the color filter substrate, in a layer structure of a polarizer, or in a glue layer where an upper polarizer and a glass cover-plate are bonded.

Moreover, with regard to a liquid crystal display device using an out-cell touch structure, the electrical shielding layer can be used to prevent a coupling electric field of data drive electrodes from imposing any influences on an out-cell touch signal.

In addition, for a liquid crystal display device using an in-cell touch structure, the electrical shielding layer, as a necessity, can effectively shield influences on a touch signal by an electrostatic accumulation field, generated due to accumulation of external charges. Such influences will cause decrease in signal to noise ratio (SNR).

Regarding the FFS-LCD, the impedance value of the electrical shielding layer should be as small as possible. With a small impedance value, electrostatic charges accumulated on the surface of the screen can be rapidly led out, thereby preventing disturbing effects of an electrostatic field. In connection with the liquid crystal display device using an out-cell touch structure, the requirements for the electrical shielding layer are the same as those in connection with the FFS-LCD. Since a capacitive screen is separated from a display screen, when the capacitive screen is touched with a finger, smooth operation can be achieved. Scanning and detecting signals of the capacitive screen will be shielded by the electrical shielding layer located therebelow. Thus, distortion of the liquid crystal molecules can be prevented from being disturbed, and meanwhile, data signals of the display screen will, due to existence of the electrical shielding layer thereabove, not be coupled to influence the signal of the touch screen. On the other hand, the liquid crystal display device using an in-cell touch structure has different requirements for impedance of the electrical shielding layer from the FFS-LCD or the liquid crystal display device using an out-cell touch structure. Since a touch functional layer is embedded into the display screen, excessively low impedance of the electrical shielding layer would cause touch sensitivity of the finger to be shielded, thus remarkably lowering touch sensitivity, or even destroying the touch function. However, excessively high impedance of the electrical shielding layer could render effective isolation of noises impossible, thus significantly reducing the SNR.

FIG. 1 shows a liquid crystal display panel 100 in the prior art. As depicted in FIG. 1, the liquid crystal display panel 100 comprises, from the bottom up, a lower polarizer 101, an array substrate 102 (including a thin film transistor array, a touch sensor, and a common electrode or grounding electrode 107), a liquid crystal layer (not shown in the figure), a color filter substrate 103, an upper polarizer 104, and an electrical shielding layer 105. The electrical shielding layer 105 is, through silver plasma 106, electrically connected to the common electrode or grounding electrode 107. Under such circumstances, in a manufacturing procedure, the electrical shielding layer 105 is first manufactured on a surface of the upper polarizer 104, and the polarizer 104 is then attached, followed by dotting of the silver plasma 106. As can be seen, the liquid crystal display panel 100 as shown in FIG. 1 is of a complicated manufacturing procedure, large thickness, and high costs, wherein multiple steps that would easily cause errors are included.

FIG. 2 shows a partial detail view of an engagement area between the electrical shielding layer 105 and a triacetate fibrous layer 104.1 of the upper polarizer 104 of the liquid crystal display panel 100 in FIG. 1. As FIG. 2 explicitly illustrates, in the liquid crystal display panel 100, the electrical shielding layer 105 includes a plurality of conductive macromolecules 105.1 therein, and the electric shielding layer 105 is entirely arranged on the triacetate fibrous layer 104.1 of the upper polarizer 104. FIG. 2 shows the engagement area between the two clearly.

FIG. 3 shows another liquid crystal display panel 200 in the prior art. The liquid crystal display panel 200 comprises, from the bottom up, a lower polarizer 201, an array substrate 202 (including a thin film transistor array, a touch sensor, and a common electrode or grounding electrode 207), a liquid crystal layer (not shown in the figure), a color filter substrate 203, an electrical shielding layer 205, and an upper polarizer 204. The electrical shielding layer 205 is, through silver plasma 206, electrically connected to the common electrode or grounding electrode 207. Under such circumstances, in a manufacturing procedure, the electrical shielding layer 205 is first manufactured on an upper surface of the color filter substrate 203 (through, for example, evaporation sputtering of an ITO electrical shielding layer), and the silver plasma 206 is then dotted, followed by attachment of the upper polarizer 204. As can be seen, the liquid crystal display panel 200 as shown in FIG. 3 is also of a complicated manufacturing procedure, large thickness, and high costs, wherein multiple steps that would easily cause errors are included.

To conclude the above, in each of the two existing liquid crystal display panels as shown in FIGS. 1 and 3, besides an inherent structure, i.e., the upper polarizer 104 or 204, a conductive macromolecule layer 105 or a metal oxide layer 205 is further added. This would cause certain loss of transmissivity, thereby reducing transmissivity of the panel.

### SUMMARY OF THE INVENTION

Directed against the problems existing in the prior art, i.e., the impedance of the electrical shielding layer in the liquid crystal display panel in the prior art is difficult to control, and light transmissivity is reduced thereby, the present disclosure provides an improved liquid crystal display panel.

In one embodiment, a liquid crystal display panel according to the present disclosure comprises an array substrate, a color filter substrate, and a liquid crystal layer disposed therebetween, wherein a photoelectric functional layer, which is arranged on a surface of the color filter substrate facing the liquid crystal layer or on a surface of the color filter substrate away from the liquid crystal layer, can influence polarization states of optical waves, and meanwhile generate electrical shielding effects. As such, the photoelectric functional layer, which has two functions, can serve as either a polarizer or an electrical shielding layer, thus simplifying a manufacturing procedure of the entire liquid crystal display panel.

In one embodiment, the photoelectric functional layer is disposed to have a metal wire grid structure at a position corresponding to an active area. The impedance of a metal wire grid structure layer in the active area can be controlled through the thickness of the metal layer. Such being the case, the thickness of metal in the metal wire grid structure layer can be relatively large in connection with the FFS-LCD and the liquid crystal display device using an out-cell touch structure (which require small impedance) as explained above under Background of the Invention. Alternatively, the metal layer can be adjusted in width, such as being widened. With regard to the liquid crystal display device using an in-cell touch structure (which requires a relatively large impedance) as explained above under Background of the Invention, the metal wire grid structure layer can be thinned or narrowed down, so as to be adjusted to have a proper level of impedance.

In one embodiment, the photoelectric functional layer comprises, at a position corresponding to an edge of the display panel, a metal frame electrically connected to the metal wire grid structure, which is located in one and a same layer and meanwhile forms a pattern with the metal frame. An electrically interconnected metal layer (i.e., the metal frame) located in the positions other than the active area can bring about the following advantages. The electrostatic charges accumulated on a surface of the display device can be rapidly led out from all peripheral positions. Compared with the electrical shielding layer used in the prior art, the conducing dielectric employed in the present disclosure has a larger conductive rate.

In one embodiment, the metal frame is electrically connected to a common electrode or grounding electrode.

In one embodiment, silver plasma is dotted to build bridge connection of the metal frame to a bonding pad located at a bonding IC of the array substrate, and the bonding pad is connected, through a flexible circuit board, to an external common electrode signal or grounding signal.

In one embodiment, the metal wire grid structure is made of one of metal Al, Mo, Au, and Cr, or an alloy thereof. A metal material, being different from general inorganic or organic materials in conductive characteristics, has relatively small electrical impedance. A proper impedance value of a metal layer can be obtained just through reasonable control of thickness of the metal layer.

In one embodiment, the metal wire grid structure is a mono-layer or double-layer metal wire grid structure.

In one embodiment, in the mono-layer metal wire grid structure, at least two parallel metal strips extending along one and a same direction are provided on the surface of the color filter substrate, and a wire grid gap is formed between every two adjacent metal strips. The metal strips each have a same height in a direction perpendicular to the surface of the color filter substrate.

In one embodiment, in the double-layer metal wire grid structure, at least two parallel metal strips and at least two parallel dielectric strips all extending along one and a same direction are provided on the surface of the color filter substrate, and the metal strips and the dielectric strips are alternately arranged without any gaps formed therebetween. Each of the dielectric strips is, on a surface thereof away from the color filter substrate, further covered with the metal strip.

In one embodiment, in the direction perpendicular to the surface of the color filter substrate, the metal strips each have a same size, and the dielectric strips each have a height larger than the size of the metal strip.

In the above two alternatives, incident light substantially has a polarization direction either in parallel with the metal strips or perpendicular to the metal strips; reflected light substantially has a polarization direction parallel to the metal strips; and transmitted light substantially has a polarization direction perpendicular to the metal strips.

The above technical features can be combined in any suitable manner or replaced by any equivalent technical features so long as the purpose of the present disclosure can be achieved.

### BRIEF DESCRIPTION OF THE DRAWINGS

The present disclosure will be described in more detail in light of the embodiments and drawings, wherein:

FIG. 1 shows a liquid crystal display panel in the prior art;

FIG. 2 shows a partial detail view of an engagement area between an electrical shielding layer and an upper polarizer of the liquid crystal display panel as shown in FIG. 1;

FIG. 3 shows another liquid crystal display panel in the prior art;

FIG. 4 schematically shows the structure of a liquid crystal display panel according to the present disclosure;

FIG. 5 shows an electrical shielding layer according to a first embodiment of the liquid crystal display panel of the present disclosure; and

FIG. 6 shows an electrical shielding layer according to a second embodiment of the liquid crystal display panel of the present disclosure.

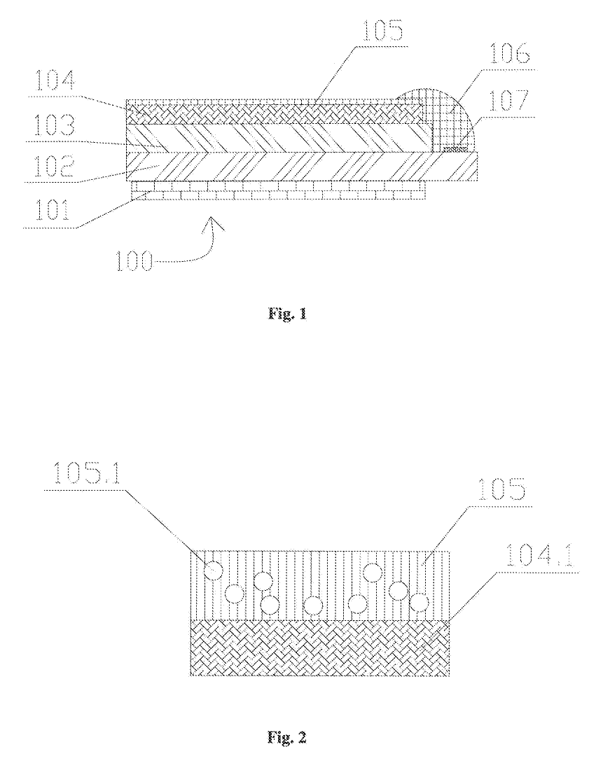

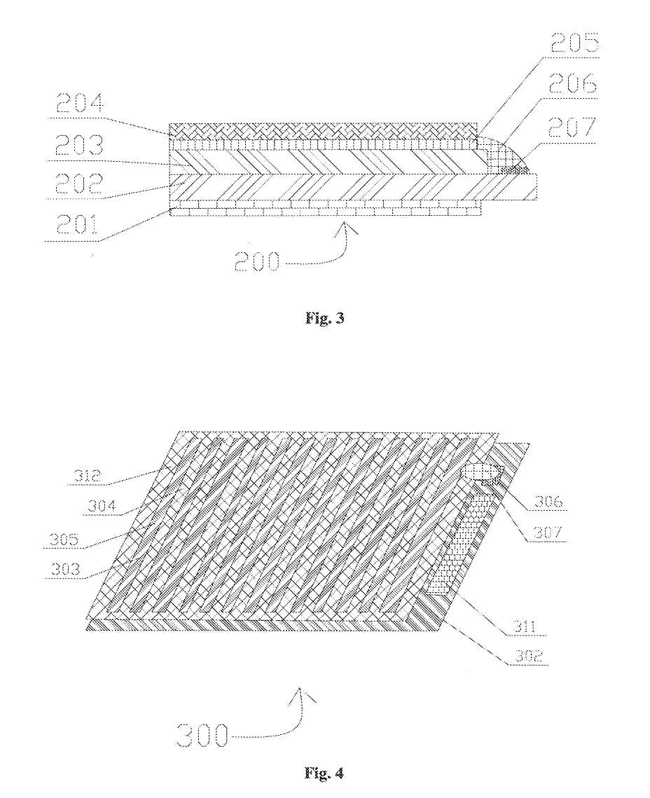

In the accompanying drawings, the same components are indicated by the same reference signs. The accompanying drawings are not drawn to an actual scale.

### DETAILED DESCRIPTION OF THE EMBODIMENTS

The present disclosure will be further explained with reference to the accompanying drawings.

FIG. 4 schematically shows the structure of a liquid crystal display panel according to the present disclosure.

In one embodiment as shown in FIG. 4, a liquid crystal display panel 300 according to the present disclosure comprises an array substrate 302, a color filter substrate 303, and a liquid crystal layer (not shown) disposed therebetween. A photoelectric functional layer is provided on a surface of the color filter substrate 303 facing the liquid crystal layer, or on a surface of the color filter substrate 303 away from the liquid crystal layer. The photoelectric functional layer can influence polarization states of optical waves, and meanwhile generate electrical shielding effects.

Further, the photoelectric functional layer is arranged to have a metal wire grid structure 304 at positions corresponding to an active area. The metal wire grids are provided with spaces 305 therebetween. The photoelectric functional layer comprises, at a position corresponding to an edge of the display panel, a metal frame 312 electrically connected to the metal wire grid structure 304. In terms of structure, the metal wire grid structure 304 and the metal frame 312 can be allowed to locate in one and a same layer, and meanwhile form a pattern.

The electric field vector of transmitted light through the wire grid structure, termed as P light (or TM wave), is perpendicular to the wire grid, while the electric field vector of reflected light from the wire grid structure, termed as S light (or TE wave), is parallel with the wire grid. Where aluminum, for example, is used as the metal material for the metal wire grid structure, a real part and an imaginary part of an equivalent refractive index of the TE wave aluminum grating layer will be both large. As such, the aluminum layer will be equivalent to a metal film, and the TE wave will be largely reflected or absorbed. On the other hand, a real part of an equivalent refractive index of the TM wave aluminum layer is relatively large, while an imaginary part thereof is relatively small. Such being the case, the aluminum layer will be equivalent to a dielectric layer having weak absorption properties, and the TM wave will therefore largely penetrate therethrough. The cycle pitch of the metal wire grid is typically smaller than the wave length of visible light. That is, the metal wire grid is a sub-wavelength metal wire grid.

The metal frame 312 can be electrically connected to a common electrode or grounding electrode. Specifically, silver plasma 306 can be dotted to build bridge connection of the metal frame 312 to a bonding pad 307 located at a bonding IC of the array substrate 302. The bonding pad 307 can be connected to an external common electrode or grounding electrode through a flexible circuit board. As FIG. 4 explicitly shows, the bonding pad 307 can be located adjacent to a data drive circuit 311.

In terms of composition of materials, the metal wire grid structure 304 can be made of one of metal Al, Mo, Au, and Cr, or an alloy thereof. A metal material, being different from general inorganic or organic materials in conductive characteristics, has relatively small electrical impedance. And a proper impedance value of a metal layer can be obtained simply through reasonable control of thickness of the metal layer.

Dependent on different conditions, the metal wire grid structure 304 can be either a mono-layer metal wire grid structure or a double-layer metal wire grid structure.

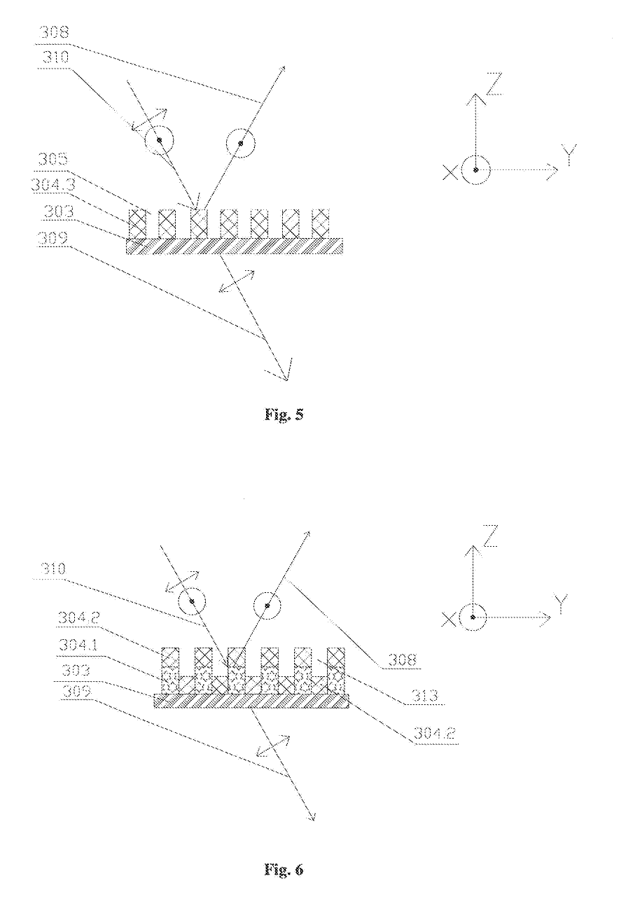

FIG. 5 shows an electrical shielding layer according to a first embodiment of the liquid crystal display panel of the present disclosure. In the first embodiment, the metal wire grid structure 304 is a mono-layer wire grid structure. In the mono-layer metal wire grid structure 304, at least two parallel metal strips 304.3 extending along one and a same direction are arranged on the surface of the color filter substrate 303, and a wire grid gap 305 is formed between every two adjacent metal strips 304.3. In a direction perpendicular to the surface of the color filter substrate 303, the metal strips 304.3 each have a same height. As FIG. 5 explicitly illustrates, incident light 310 substantially has a polarization direction either in parallel with the metal strips 304.3 or perpendicular to the metal strips 304.3; reflected light 308 substantially has a polarization direction in parallel with the strips 304.3; and transmitted light 309 substantially has a polarization direction perpendicular to the metal strips 304.3.

FIG. 6 shows an electrical shielding layer according to a second embodiment of the liquid crystal display panel of the present disclosure. In the second embodiment, the metal wire grid structure 304 is a double-layer wire grid structure. In the double-layer wire grid structure, at least two parallel metal strips 304.2 and at least two parallel dielectric strips 304.1 all extending along a same direction are provided on the surface of the color filter substrate 303. The metal strips 304.2 and the dielectric strips 304.1 are alternately arranged without any gaps formed therebetween. Each of the dielectric strips 304.1 is, on a surface thereof away from the color filter substrate 303, further covered with the metal strip 304.2. The dielectric strips 304.1 are transparent. A gap, which is filled with the dielectric strip 304.1, is formed between any two adjacent metal strips 304.2 that are located in a first layer of metal strips 304.2. And a gap 313 is formed between any two adjacent metal strips 304.2 that are located in a second layer of metal strips 304.2. It can be explicitly seen from FIG. 6, in the direction perpendicular to the surface of the color filter substrate 303, the metal strips 304.2 each have a same size, and the dielectric strips 304.1 each have a height larger than the size of the metal strip 304.2.

As FIG. 6 further indicates in a clear manner, the incident light 310 substantially has a polarization direction either in parallel with the metal strips 304.2 or perpendicular to the metal strips 304.2; the reflected light 308 substantially has a polarization direction in parallel with the metal strips 304.2; and the transmitted light 309 substantially has a polarization direction perpendicular to the metal strips 304.2.

Through comparison between the above two alternatives, it can be seen that, in the mono-layer metal wire grid structure, metal wire grids of one and a same height are provided on the surface of one and a same transparent substrate; while in the double-layer metal wire grid structure, metal wire grids of two different heights are alternately provided on the surface of one and a same transparent substrate. In terms of manufacturing procedure only, the double-layer metal wire grid structure can be more simply manufactured.

To sum up the foregoing, the present disclosure provides a polarizer of a nano-metal wire grid structure. The polarizer can be either in the mono-layer metal wire grid structure or in the double-layer metal wire grid structure. The metal wire grid structure is located on an upper glass substrate of a liquid crystal cell, i.e., the color filter substrate, either on an upper surface or a lower surface thereof. At a position of the color filter substrate corresponding to a display edge (non-display window area), a region connected to the metal wire grid structure is maintained to be planar (i.e., the metal frame). The planar metal layer can be dotted with silver plasma, so as to be bridge connected to the bonding pad located at the bonding IC area of a lower glass substrate. The bonding pad can be, through the flexible circuit board, connected to an external main circuit board, and to the common electrode signal or to the grounding signal.

The metal wire grid structure for polarization effects is merely located in a window area of display (i.e., an active area (AA) of display), while other positions of the upper substrate except a position thereof corresponding to the AA, are provided with an electrically interconnected metal layer, i.e., the metal frame, which can be formed while a metal wire grid pattern is being formed in the AA. A periphery of the metal layer can, through conductive silver plasma, connect to the common electrode or grounding electrode of the lower substrate.

The liquid crystal display panel of the present disclosure can bring about numerous benefits.

At the outset, a metal wire grid structure layer, which has two functions, can serve as either the polarizer or the electrical shielding layer, thereby simplifying the manufacturing procedure of the entire liquid crystal display panel.

Moreover, the impedance of the metal wire grid structure layer in the active area (AA) can be controlled through the thickness of the metal layer. Such being the case, the thickness of metal in the metal wire grid structure layer can be relatively large in connection with the FFS-LCD and the liquid crystal display device using an out-cell touch structure (which require small impedance) as explained above under Background of the Invention. Alternatively, the metal layer can be adjusted in width, such as being widened. With regard to the liquid crystal display device using an in-cell touch structure (which requires a relatively large impedance) as explained above under Background of the Invention, the metal wire grid structure layer can be thinned or narrowed down, so as to be adjusted to have a proper level of impedance.

In addition, the electrically interconnected metal layer (i.e., the metal frame) located in the positions other than the AA can bring about the following advantages. The electrostatic charges accumulated on the surface of the display device can be rapidly led out from all peripheral positions. Compared with the electrical shielding layer used in the prior art, the conducing dielectric employed in the present disclosure has a larger conductive rate.

Although the present disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims. It will be appreciated that the various dependent claims and the features set forth therein can be combined in different ways than presented in the initial claims. It will also be appreciated that the features described in connection with individual embodiments may be shared with others of the described embodiments.

1. A liquid crystal display panel, comprising an array substrate, a color filter substrate, and a liquid crystal layer disposed therebetween,
Wherein a photoelectric functional layer, which is arranged on a surface of the color filter substrate facing said liquid crystal layer or on a surface of the color filter substrate away from said liquid crystal layer, can influence polarization states of optical waves, and meanwhile generate electrical shielding effects.

2. The liquid crystal display panel according to claim 1, wherein the photoelectric functional layer is arranged to have a metal wire grid structure at a position corresponding to an active area.

3. The liquid crystal display panel according to claim 2, wherein the photoelectric functional layer comprises, at a position corresponding to an edge of the display panel, a metal frame electrically connected to the metal wire grid structure, which is located in one and a same layer and meanwhile forms a pattern with the metal frame.

4. The liquid crystal display panel according to claim 3, wherein the metal frame is electrically connected to a common electrode or grounding electrode.

5. The liquid crystal display panel according to claim 4, wherein silver plasma is dotted to build bridge connection of the metal frame to a bonding pad located at a bonding IC of the array substrate, the bonding pad being connected, through a flexible circuit board, to an external common electrode signal or grounding signal.

6. The liquid crystal display panel according to claim 3, wherein the metal wire grid structure is made of one of metal Al, Mo, Au, and Cr, or an alloy thereof.

7. The liquid crystal display panel according to claim 2, wherein the metal wire grid structure is either a mono-layer or double-layer metal wire grid structure.

8. The liquid crystal display panel according to claim 7, wherein in the mono-layer metal wire grid structure, at least two parallel metal strips extending along one and a same direction are provided on the surface of the color filter substrate, and a wire grid gap is formed between every two adjacent metal strips, and
wherein the metal strips each have a same height in a direction perpendicular to the surface of the color filter substrate.

9. The liquid crystal display panel according to claim 7, wherein in the double-layer metal wire grid structure, at least two parallel metal strips and at least two parallel dielectric strips along extending one and a same direction are provided on the surface of the color filter substrate,
wherein the metal strips and the dielectric strips are alternately arranged without any gaps formed therebetween, and
wherein each of the dielectric strips is, on a surface thereof away from the color filter substrate, further covered with the metal strip.

10. The liquid crystal display panel according to claim 9, wherein in a direction perpendicular to the surface of the color filter substrate, the metal strips each have a same size, and the dielectric strips each have a height larger than the size of the metal strip.
